(19) United States
(12) Patent Application Publication
(10) Pub. No.: US 2025/0214189 A1
(43) Pub. Date: Jul. 3, 2025

(54) CONTAMINATION CONTAINMENT SHIELD

(71) Applicant: James R. Singletary, III, Ruskin, FL (US)

(72) Inventor: James R. Singletary, III, Ruskin, FL (US)

(21) Appl. No.: 18/403,025

(22) Filed: Jan. 3, 2024

Related U.S. Application Data
(60) Provisional application No. 63/382,159, filed on Nov. 3, 2022.

(51) Int. Cl. B23Q 11/08

(52) U.S. Cl. CPC B23Q 11/0816

(57) ABSTRACT

A contamination containment shield includes a sleeve and an enclosure. The sleeve may include a sleeve proximal end and a sleeve distal end. The sleeve proximal end may be configured to attach to a chuck of the drill machine. The enclosure may include an enclosure proximal end and an enclosure distal end. The enclosure proximal end may be attached to the sleeve distal end. The enclosure may be formed of multiple baffles disposed circumferentially around the enclosure.

### CROSS-REFERENCE TO RELATED APPLICATION

This application claims the benefit of priority of U.S. provisional application No. 63/382,159, filed Nov. 3, 2022, the contents of which are herein incorporated by reference.

### BACKGROUND OF THE INVENTION

### Field of the Invention

The present invention relates to a power drill, and more particularly to a contamination containment shield.

### Description of the Related Art

Operators in the construction industry often encounter debris on their faces and in their eyes while drilling into concrete, metal, wood, etc. Due to this, the operators may suffer small cuts and other problems, which may be undesirable.

Thus, there exists a need for a device that protects the operator, work station, and job site from silica contamination during the drilling operation process.

### SUMMARY OF THE INVENTION

The following presents a simplified summary of the present disclosure in a simplified form as a prelude to the more detailed description that is presented herein.

In accordance with embodiments of the invention, there is provided a contamination containment shield operative to contain contaminants such as silica and/or concrete dust. The contamination shield may include a sleeve and an enclosure. The sleeve may include a sleeve proximal end and a sleeve distal end. The sleeve proximal end may be configured to attach to a chuck of a drill machine. The enclosure may include an enclosure proximal end and an enclosure distal end. The enclosure proximal end may be attached to the sleeve distal end. The enclosure may include a plurality of baffles disposed circumferentially around the enclosure.

The inventive shield is sometimes referred to herein as “SaveFace”. The shield is generally an attachment comprising a flanged sleeve that securely fits on the shaft of a drill bit, having multiple graduated baffles and a base ring. The shield attachment protects the operator from debris while using the drill. The attachment may fit more than one manufacturer's drill housing, or a different element may be produced for each manufacturer's drill housing. The dimensions may be determined by the housing dimensions. For example, a housing sheath portion, i.e., a sleeve or neck, may have an inner diameter of about 26 mm and may extend to a portion having an aperture with an inner diameter of about 10 mm through which the shaft of the drill bit passes. The length of the shield in an extended condition may be about 6-7 inches. The height of a base portion of the shield is not particularly limited and may have a height of about ½ inch to about ¾ inches.

In some aspects, the plurality of baffles may be disposed along an entire length of the enclosure. The sleeve, base ring, and plurality of baffles may be made of rubber or plastic, such as natural rubber, neoprene rubber, silicone rubber, nitrile rubber, ethylene propylene diene monomer (EPDM) rubber, styrene-butadiene rubber (SBR), butyl rubber, fluorosilicone rubber, polyacrylic, polycarbonate, high-density polyethylene, polyvinyl chloride, acrylic-polyvinyl chloride, acrylonitrile butadiene styrene, polyurethane, or any combination thereof. The contamination shield may further include a base ring connected to the enclosure distal end.

In some aspects, the enclosure may be configured to move between a compressed state and a decompressed state. A length of the enclosure may be greater than a length of a drill bit in the decompressed state. In some aspects, the enclosure may be conical in shape.

The present disclosure is further directed towards a drill machine. The drill machine may include a chuck and a contamination shield described above.

The present disclosure discloses a contamination shield that protects the operator's face/eyes from debris that may be generated during drilling of a surface. The contamination shield is easy to install and remove. In addition, the contamination shield is easy to clean.

These and other features, aspects, and advantages of the present invention will become better understood with reference to the following description and appended claims.

### BRIEF DESCRIPTION OF THE DRAWINGS

Illustrative embodiments of the present invention are described herein with reference to the accompanying drawings, in which:

FIG. 1 is a perspective view of a contamination cover/shield attached to a drill machine in accordance with the present disclosure.

FIG. 2 is another perspective view of a contamination cover/shield in accordance with the present disclosure.

FIG. 3 is a sectional view thereof, taken along line 3-3 in FIG. 1 in accordance with the present disclosure.

FIG. 4 is a perspective view thereof, shown in a partially compressed condition in accordance with the present disclosure.

FIG. 5 is a perspective view thereof, shown in a fully compressed condition in accordance with the present disclosure.

FIG. 6 is a sectional view thereof, taken along line 6-6 in FIG. 4 in accordance with the present disclosure, shown in use.

FIG. 7 is a sectional view thereof, taken along line 7-7 in FIG. 5 in accordance with the present disclosure, shown in use.

FIG. 8 is another sectional view of the contamination cover/shield in accordance with the present disclosure.

FIG. 9 is yet another sectional view of the contamination cover/shield in accordance with the present disclosure.

### DETAILED DESCRIPTION OF INVENTION

For a further understanding of the nature and function of the embodiments, reference should be made to the following detailed description. Detailed descriptions of the embodiments are provided herein, as well as, the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure.

Reference will now be made in detail to the present preferred embodiments of the invention, examples of which are illustrated in the accompanying drawings. Wherever possible, the same reference numerals are used in the drawings and the description to refer to the same or like parts.

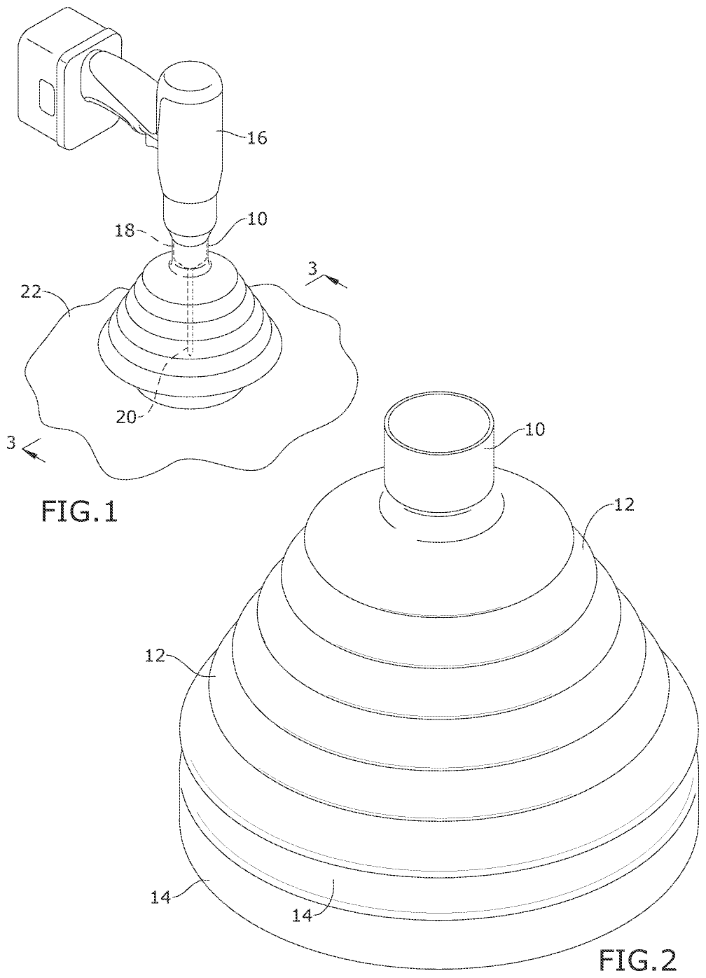

FIG. 1 depicts a perspective view of a contamination cover/shield attached to a drill machine in accordance with the present disclosure. FIG. 1 will be described in conjunction with the FIGS. 2-9.

The drill machine may be any drilling machine that may be configured to drill holes in concrete, metal, wood, etc. For example, the drill machine may be a Slotted Drive Shaft (SDS) drill, a hammer drill, and/or the like. The sleeve may snugly fit around an about ½ inch to about ¾ inch portion of the SDS drill chuck. The drilling machine may include a power drill having a drill housing 16. The drill machine may further include a drill chuck 18 that may be connected to the drill housing 16 (e.g., at an end of the drill housing 16). The drill chuck 18 may be a clamping device that may be configured to hold various tools (including a drill bit 20, described below).

The drilling machine may further include the drill bit 20 that may be connected to the drill chuck 18. The drill bit 20 may be a cutting tool that may be configured to remove material to create holes in concrete, metal, wood, etc. The drill bit 20 may be of any size and may be of any type.

In accordance with the present disclosure, the drilling machine may be removably attached to a contamination shield that may be configured to protect face/eyes of an operator during a drilling operation (i.e., during the usage of the drilling machine). In some aspects, the contamination shield may be configured to cover the drill bit 20. In an exemplary aspect, the contamination shield may be configured to completely enclose the drill bit 20 from the sides. The contamination shield may be made of a durable and flexible material. In some aspects, the contamination shield may be made of any material including, but not limited to, plastic, rubber, and/or the like. In further aspects, the contamination shield may be transparent to allow the operator to view position of the drill bit 20 inside the contamination shield, and to place the drill bit 20 in the desired/selected position for drilling. In some aspects, the contamination shield may be a single, monolithic piece. Alternatively, the contamination shield may include two or more components that may be removably attached with each other. In further aspects, the contamination shield may be made from injection molding.

In some aspects, the contamination shield may include a sleeve 10 (or sleeve coupling) that may be configured to removably attach the contamination shield to the drill chuck 18. The sleeve 10 may be configured to snugly fix/attach to the drill chuck 18 along with the drill bit 20, encompassing the drill chuck 18. In some aspects, the sleeve 10 may be a hollow tubular rod (or cylindrical rod) that may be a part of the contamination shield. Stated another way, the sleeve 10 may be an integral part of the contamination shield. Alternatively, the sleeve 10 may not be an integral part of the contamination shield, and may be removably attached to other parts/components of the contamination shield.

In some aspects, a diameter (e.g., an outer diameter) of the sleeve 10 may be equivalent to (or less than or greater than) a diameter (e.g., an inner diameter) of the drill chuck 18 to enable/facilitate coupling of the contamination shield to the drill chuck 18. The sleeve 10 may include an upper end (e.g., a sleeve proximal end) and a lower end (e.g., a sleeve distal end). The upper end may be connected to the drill chuck 18 and the lower end may be connected to a protective enclosure, as described below. In some aspects, the upper end and the lower end may be open ends.

The contamination shield may further include the protective enclosure that may enclose the drill bit 20 from the sides, to retain debris 24 generated during drilling within the walls of the protective enclosure. The protective enclosure may include an upper end (e.g., an enclosure proximal end) and a lower end (e.g., an enclosure distal end). The upper end of the protective enclosure may be attached to the lower end of the sleeve 10, and the lower end of the protective enclosure may be attached to a base ring 14. The base ring 14 may cover a bottom surface of the protective enclosure, and may be a hollow tube.

The walls of the protective enclosure may be disposed at a predetermined distance from the drill bit 20. The drill bit 20 may cross the center portion of the protective enclosure.

In some aspects, the protective enclosure may be substantially conical in shape. In such an embodiment, a diameter of the upper end of the protective enclosure (in proximity to the sleeve 10) may be less than a diameter of the lower end of the protective enclosure (in proximity to the base ring 14). Stated another way, the diameter of the protective enclosure may increase gradually from the upper end of the protective enclosure to the lower end of the protective enclosure. Alternatively, the diameter of the upper end of the protective enclosure may be the same as the diameter of the lower end of the protective enclosure.

As described above, the base ring 14 may be attached to the lower end of the protective enclosure. The base ring 14 may be removably attached to the lower end, or the base ring 14 may be integrated to the lower end. In some aspects, the diameter of the lower end of the protective enclosure may be the same as a diameter of the base ring 14. Alternatively, the diameter of the lower end of the protective enclosure may be different from the diameter of the base ring 14. In further aspects, the diameter of the base ring 14 may be consistent throughout the length of the base ring 14.

The base ring 14 may be disposed in proximity to (or may contact) a surface 22 on which the drilling operation may be performed. In some aspects, the material of the contamination shield (e.g., the protective enclosure) may be the same as the material of the base ring 14. Alternatively, the material of the protective shield (e.g., the protective enclosure) may be different from the material of the base ring 14.

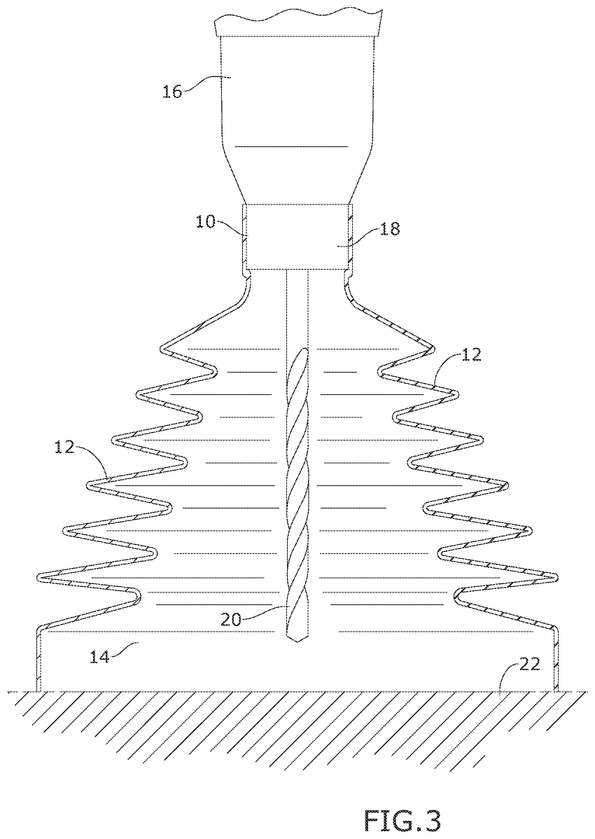

In some aspects, the protective enclosure may include a plurality of baffles 12 that may be present/disposed throughout the length of the protective enclosure. The plurality of baffles 12 may be disposed circumferentially (e.g., continuously or in a continuous manner) throughout the length of the protective enclosure. In an exemplary aspect, the protective enclosure may include a series of deformable ridges and cavities/troughs that may be present throughout the length of the protective enclosure (as shown at least in FIG. 3) that form the baffles 12. A cavity may be disposed between each adjacent ridge. Stated another way, adjacent ridges may be separated by a recess.

The plurality of baffles 12 may be connected between the sleeve 10 and the base ring 14. The plurality of baffles 12 may be flow-directing or obstructing vanes that may be configured to direct the flow of debris 24 such that the debris 24 does not come out of the protective enclosure. In some aspects, the diameter of a first baffle may be different from a diameter of an adjacent second baffle. The diameters of the baffles 12 increase gradually from the upper end of the protective enclosure to the lower end of the protective enclosure.

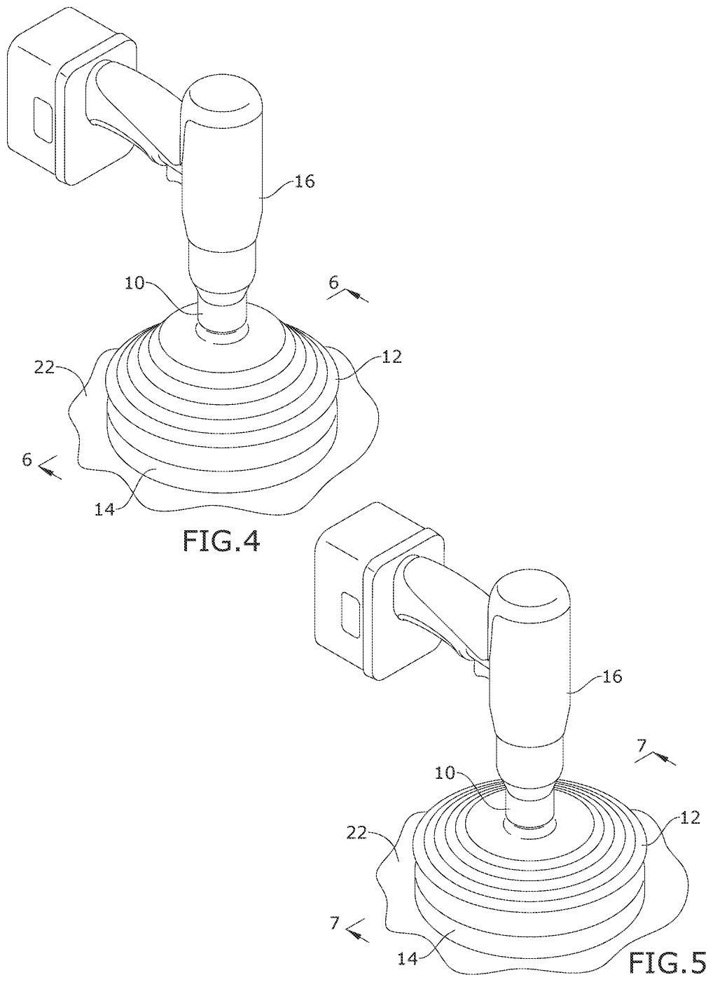

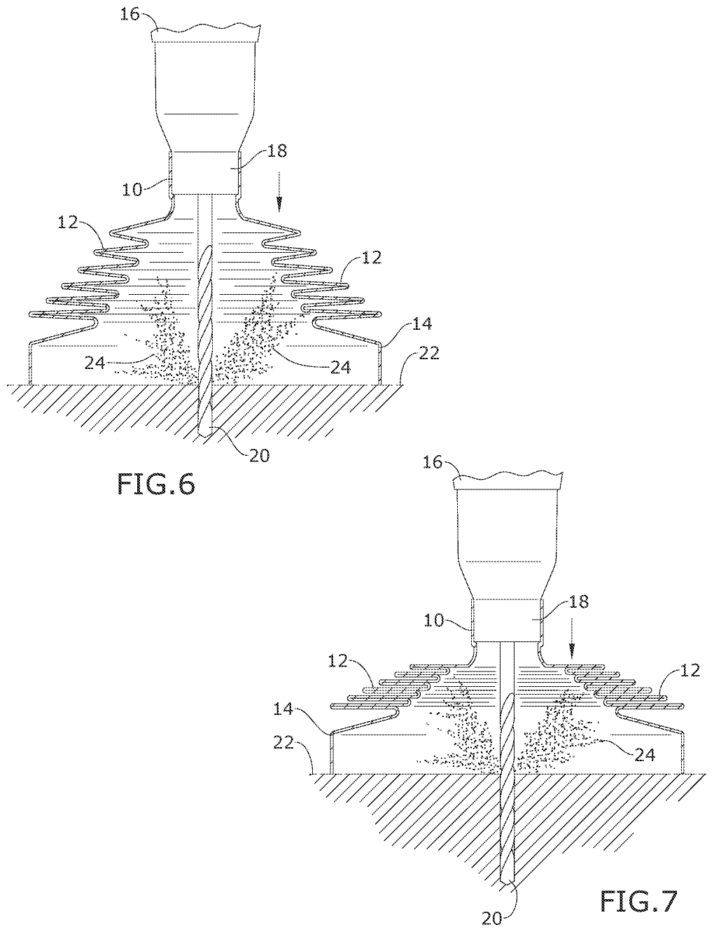

In some aspects, the plurality of baffles 12 may be configured to compress (or move to a compressed state) along a length of the protective enclosure, when pressure or force is longitudinally applied to the contamination shield. For example, the plurality of baffles 12 may compress when the operator pushes the drill machine against the surface 22 for drilling. In some aspects, the base ring 14 may not compress when the plurality of baffles 12 may be compressed. FIGS. 4 and 6 depict a view when the plurality of baffles 12 may be partially compressed, and FIGS. 5 and 7 depict a view when the plurality of baffles 12 may be completely compressed. The plurality of baffles 12 may be decompressed (or move back to a decompressed state) when the operator removes the pressure against the surface 22. When the plurality of baffles 12 may be decompressed, the protective enclosure (e.g., some of the baffles and/or the base ring 14) may extend beyond the drill bit 20. Stated another way, a length of the protective enclosure may be greater than a length of the drill bit 20 when the protective enclosure may be in the decompressed state. In the compressed state, the protective enclosure (and/or the base ring 14) may not extend beyond the drill bit 20.

In operation, the operator may attach the contamination shield to the drill by snugly fitting the sleeve 10 to the drill chuck 18. The operator may then position the base ring 14 against the surface 22 to be drilled, and then active the drill machine. The operator may then apply pressure against the surface 22 to drill a hole in the surface 22. When the operator applies the pressure, the plurality of baffles 12 may be compressed (i.e., move from an original position to a compressed position) and may prevent debris 24 to move out of the contamination shield. The plurality of baffles 12 may remain in the compressed position until the operator releases the pressure or until the hole is created. When the operator releases the pressure, the plurality of baffles 12 may be decompressed (i.e., move back to the original position).

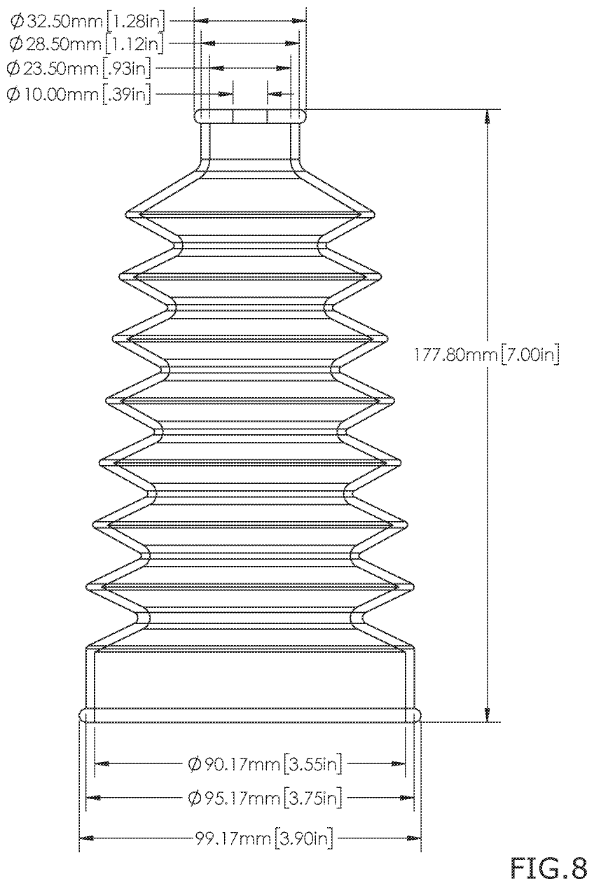

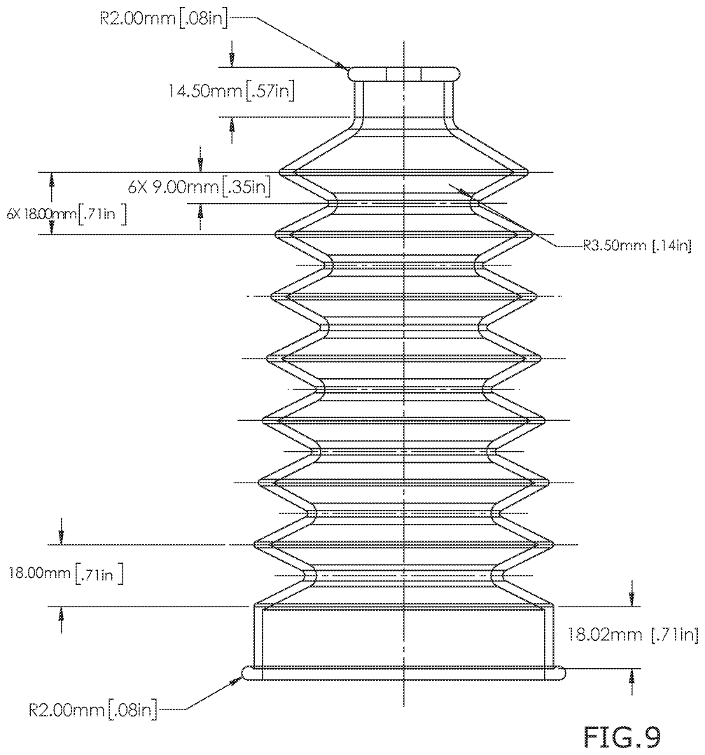

FIGS. 8-9 depict exemplary dimensions of the contamination shield. In some aspects, the contamination shield may have a height in the range of about 5-8 inches. In an exemplary embodiment, the contamination shield may have a height of about 7 inches. In addition, an inner diameter of the baffles disposed in proximity to the base ring 14 may be about 3.55 inches, and the outer diameter may be about 3.75 inches. In further aspects, an outer diameter of the base ring 14 may be about 3.90 inches. Alternatively, the inner diameter of the base ring 14 may be about 3.55 inches and the outer diameter may be about 3.75 inches. In further aspects, the sleeve 10 may have an inner diameter of about 0.93 inches, and an outer diameter of about 1.12 inches or about 1.28 inches. In addition, the drill bit 20 may pass through a center portion of the sleeve 10. The diameter of the center portion may be about 0.39 inches.

In further aspects, the base ring 14 may have a height of about 0.71 inches, and the distance/gap between two ridges may be about 0.71 inches (e.g., in a decompressed position). In addition, a gap between a ridge and a cavity may be about 0.35 inches. In addition, the height of the sleeve 10 may be about 0.57 inches. In some aspects, a thickness of the plurality of baffles 12 may be about 0.14 inches.

The dimensions mentioned above are exemplary in nature and should not be construed as limiting. Any other dimension may be used without changing the scope of the present disclosure.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation within the spirit and scope of the appended claims.

The claimed invention is:

1. A contamination shield comprising:
a sleeve having a sleeve proximal end and a sleeve distal end, wherein the sleeve proximal end is configured to attach to a chuck of a drill machine; and
an enclosure having an enclosure proximal end and an enclosure distal end, wherein the enclosure proximal end is joined to the sleeve distal end, and wherein the enclosure is formed of a plurality of circular baffles.

2. The contamination shield of claim 1, wherein the plurality of circular baffles each have at least one ridge and at least one recess and wherein the at least one ridge has a greater diameter than the at least one recess.

3. The contamination shield of claim 1, further comprises a base ring joined to the enclosure distal end.

4. The contamination shield of claim 1, wherein the plurality of circular baffles is made of rubber or plastic.

5. The contamination shield of claim 1, wherein the enclosure is configured to move between a compressed state and a decompressed state.

6. The contamination shield of claim 5, wherein a length of the enclosure in the decompressed state is greater than or equal to a length of a drill bit.

7. The contamination shield of claim 1, wherein the plurality of circular baffles have graduated diameters such that the enclosure is conical in shape.

8. A drill machine comprising:
a chuck; and
the contamination shield of claim 1.
